(19) United States
(12) Patent Application Publication
(10) Pub. No.: US 2013/0317907 A1
(43) Pub. Date: Nov. 28, 2013

(54) Business to Consumer Marketing

(71) Applicants: Bin Duan, Sunnyvale, CA (US); Lap Chan, Daly City, CA (US)

(72) Inventors: Bin Duan, Sunnyvale, CA (US); Lap Chan, Daly City, CA (US)

(73) Assignee: SAP AG, Walldorf (DE)

(21) Appl. No.: 13/480,262

(22) Filed: May 24, 2012

(51) Int. Cl. G06Q 30/02

(52) U.S. Cl. 705/14.53

(57) ABSTRACT

Disclosed is a process for marketing a product that is triggered by the user. When a user browses a product on a seller's web site, the user may be presented with a product tracking mechanism. The user may trigger product tracking, including specifying kinds of product notifications on the product and how those notifications are received.

### BACKGROUND

Unless otherwise indicated herein, the approaches described in this section are not prior art to the claims in this application and are not admitted to be prior art by inclusion in this section.

Consumers typically want to purchase goods or services (products) at the lowest price possible or otherwise with the best deal possible. This is especially important during economic downturns, such as in today's economy, where the consumer must make the most of their limited money. At the same time, businesses selling their goods or services (sellers) want to be able to identify consumers who are likely to become their customers in order to increase the efficiency of their sales efforts and maximize their profit margins.

Typically advertisements of specials deals (e.g., sales pricing, two-for-one deals, “blow out” sales, and so on) are the mechanism by which to reach out to the public. Advertisements may be sent out by mass mailing (e.g., U.S. Postal Service), emailing, targeting potential customers on the web based on their browsing activity using information collected from web sites.

### BRIEF DESCRIPTION OF THE DRAWINGS

FIG. 1 illustrates an example of a system configuration in accordance with the present disclosure.

FIG. 2 illustrates an embodiment of a process flow in accordance with the present disclosure.

FIG. 3A depicts an illustrative screen on a mobile device, in accordance with an embodiment, for identifying a product.

FIG. 3B depicts an illustrative screen on a mobile device, in accordance with an embodiment, for presenting a track-it button according to the present disclosure.

FIG. 3C depicts an illustrative screen on a mobile device, in accordance with an embodiment, for presenting various notification choices according to the present disclosure.

FIG. 3D depicts an illustrative screen on a mobile device, in accordance with an embodiment, for presenting a notification list according to the present disclosure.

FIG. 4 shows a typical implementation of a specific embodiment of a seller-side server in accordance with the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

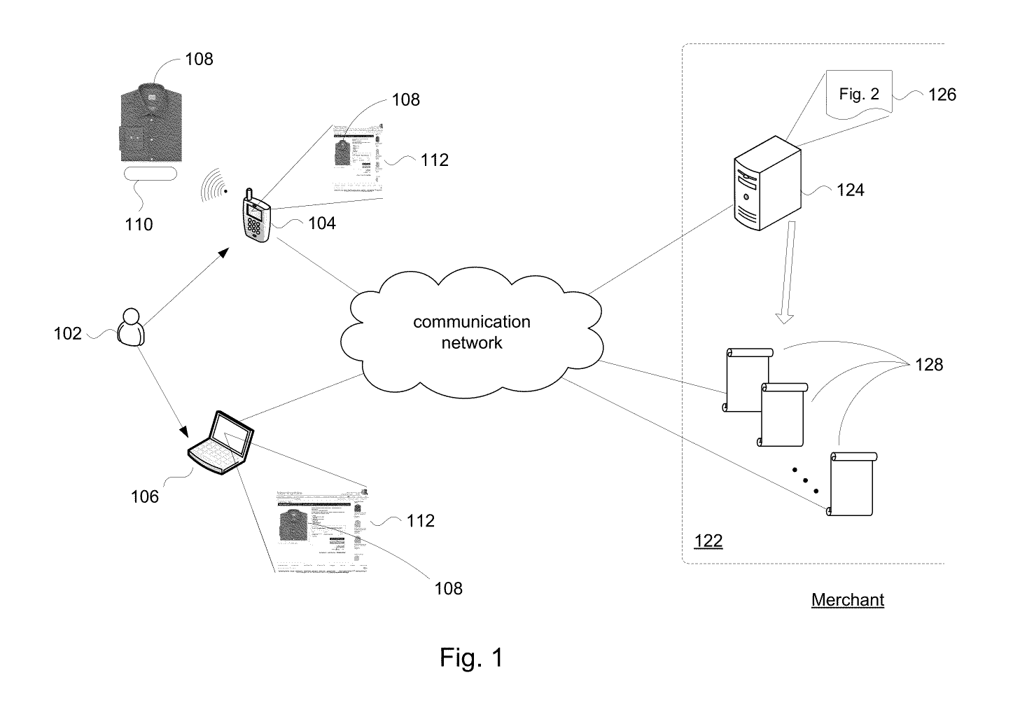

In some embodiments, such as illustrated in FIG. 1, a marketing system in accordance with the present disclosure may include a user (a potential customer) 102 using a mobile computing device 104 or any other suitable computing device 106 to identify a product 108 that the user may be interested in purchasing. The mobile computing device 104, for example, may be a smartphone, a computer tablet, and so on. Other suitable computing devices 106 may include laptop computers, desktop computers, and the like. The product 108 may include any kind of service (e.g., travel agency, plumber, auto repair, massage therapy, etc.) as well as goods. A communication network (e.g., public switch telephone network, PSTN) provides communication between the user 102 a merchant (seller) of the product 108.

The merchant may use a server system 122 to handle the merchandizing of its products. For example, the server system 122 may include a computing system 124 comprising a web server. The web server may provide users (e.g., user 102) with access to the merchant's products via web pages. The web server may provide web pages suitable for a browser running on a mobile computing device 104 or other computing device 106.

The computing system 124 may further comprise an enterprise server to manage the merchant's products. For example, the enterprise server may manage the merchant's inventory of products. The enterprise server may facilitate the development and deployment of sales campaigns for various products, and so on.

The computing system 124 may generate product notifications (announcements, advertisements, etc.) 128 for the merchant's line of products. Product notifications may be generated as part of a sales campaign, whenever the status of a product changes; e.g., price reduction, discontinuation of the produce, etc. In accordance with the present disclosure, some of these product notifications 128 may be sent or otherwise communicated to the user 102 over various communication channels.

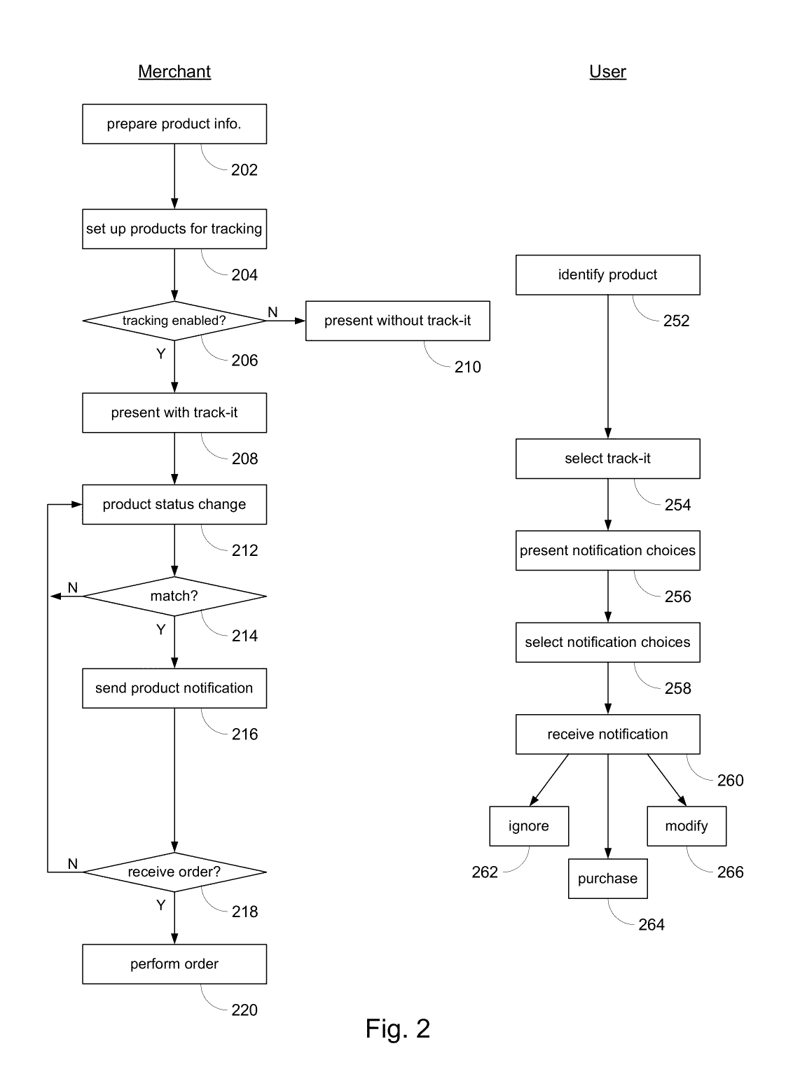

A process flow in accordance with some embodiments of the present disclosure will now be described in connection with the flow chart of FIG. 2. In block 202, the merchant may set up product descriptions for its line of products. This may include designing product description web pages containing various descriptive information about the product.

In a block 204, the merchant set up “product tracking” for several of its products. In accordance with principles of the present disclosure, product tracking allows a user 102 to designate whether they want to track status changes of a product for the purpose of possibly making a purchase of the product. A “status change” refers to a change in any aspect of the product that the merchant may expose to the user for the purpose of incentivizing a purchase. Product status may refer to price changes, inventory level of the product, plans for discontinuing the product, plans for replacing the product with a new version or new line, relocating the inventory to a new store, and so on. In accordance with the present disclosure, setting up a product for product tracking may include the merchant defining a list of notification choices for the product. As will be discussed in more detail below, the notification choices allow a user who wants to track a product to select when and how the user will be notified of changes to the status of the product.

Blocks 202 and 204 may be considered a setup phase wherein the merchant sets up its products for its web site and for product tracking. Some time later, in block 252, the user 102 may identify a product (e.g., product 108) on the merchant's web site that they are interested in purchasing. The user 102 may identify the product 108 in any of several ways. For example, the user 102 may browse the merchant's web site using a suitable web browser on their mobile computing device 104 or other computing device 106, and select the product 108 by clicking on a corresponding link to request additional information about the product. In response, the merchant's web server may present to the user 102 a product description web page corresponding to the selected product. For example, the merchant's web server may send an extended markup language (XML) document to the user's computing device 104 or 106. In accordance with the present disclosure, if the merchant had set up the selected product 108 for product tracking and product tracking is “enabled” (block 206), then the merchant's web server may incorporate in the XML document a “track-it” button (a link) and the list of notification choices defined by the merchant for the product (block 208). Conversely, if the product is not set up for product tracking, then the XML document may be sent without any of the product tracking features (block 210). It is noted that in some embodiments, although the merchant may set up product tracking for a product, the merchant may “enable” and “disable” this feature at different times.

As another example of how the user 102 may identify the product 108 (block 252), the user may visit a brick and mortar store of a retailer that sells the product and “scan” the product. Scanning can be accomplished in any of several ways. For instance, the product 108 may be associated with a bar code such as a universal product code (UPC) 110. If the user's mobile computing device 104 includes a suitable barcode scanning app, the user 102 may scan the UPC code associated with the product 108; e.g., the UPC code may printed on the product, affixed to or printed on the packaging of the product, printed on the product's display stand, and so on. The barcode scanning app may then direct the mobile computing device 104 to the merchant's web site.

Other barcode schemes may be used. For example, the brick and mortar retail store may use a 2-D barcode such as a quick response (QR) code that is associated with the retail store. Instead of scanning the product 108 itself, the user 102 may scan the QR code using a suitable app on the user's mobile computing device 104; e.g., the QR code may be provided at the entrance of the retail store. The mobile computing device 104 can use the QR code to obtain and display a list of products available at that retail store. The user 102 may then identify the product 108 from that list (block 252), and request additional information from the merchant; e.g., by visiting the merchant's web site as explained above.

In block 254, if the additional information about the product 108 includes a track-it button, the user 102 may elect to track the product, for example, by clicking on the track-it button. In response, the list of notification choices may be presented on the user's computing device 104 or 106 (block 256). In accordance with the present disclosure, the list of notification choices allow the user 102 to filter unwanted product notifications by specifying “when” they receive such product notifications from the merchant, and “how” they receive the product notifications. For example, the merchant may generate several product notifications for the product 108, which can be sent to potential customers by any of several communication channels. The notification choices allow the user 102 to say that they want to receive product notifications for the product 108 only when the product goes on sale, or when the price of the product falls below some specified price. The user 102 may want to receive a product notification when the merchant's inventory of the product 108 becomes low, or if the product will be discontinued, and so on. It will be appreciated that other conditions for when a product notification can be sent to the user are possible.

In addition to “when” product notifications can be sent to the user 102, the user may specify “how” the product notifications are to be sent; in other words, which of several communication channels to receive the product notifications. For example, the user 102 may specify an email address for receiving product notifications. If the user 102 has a facebook™ account, the user may provide their facebook™ name so they can receive posts of product notifications on their facebook account. Likewise, the user 102 can specify receiving product notifications on their twitter™ account or other similar social networking accounts. The user 102 may specify a telephone number (e.g., mobile phone), for example, to receive automated announcements from the merchant. Still other forms of communication channels are possible. The user 102 may receive product notifications over just one communication channel or over several communication channels.

In some embodiments, the user 102 may specify different communication channels for different product notifications. For example, the user 102 may specify receiving a text message from the merchant if the product 108 is about to be discontinued. However, if the product notification is about the product 108 going on sale, the user 102 may specify that those product notifications be emailed. In other words, the content of the product notification may be used to select the communication channel over which the product notification is sent.

Continuing with FIG. 2, in block 258, the user 102 i selects the “when” and “how” for receiving product notifications from the merchant, and sends the selection of product notification choices to the merchant. In some embodiments, the information that is sent to the merchant may include the following:
Customer ID
Product ID
communication channel—email, a facebook™, a twitter™, SMS, and so on
communication ID—depending on the communication channel(s) selected, this can be an email address, a facebook™ name, twitter™ account name, cell phone number, and so on
notification condition—for example, PriceDrop, AvailabilityChange, AlternativeProdcutAvailability, etc.
   The merchant's web server may store this information in a relational database table, for example. At this point, the user 102 may be deemed to have “triggered” the product notification process.

As will now be explained, when the status of the product 108 changes, product notifications may be sent to the user 102. Thus, in block 212, suppose the status of the product 108 has changed. Illustrative examples of changes in the status of the product include, but are certainly not limited a price reduction of the product 108, the product may become discontinued, the inventory of product may be moved from one brick and mortar store to another, and so on. If the status change of the product 108 matches the user's selection of notification choices regarding “when” the user 102 wants to be notified (block 214), the merchant may generate and send a product notification to the user (block 216) according to “how” the user wants to be notified (e.g., in an email, on their facebook™ account, etc.). Otherwise, the user 102 is not notified.

When the user 102 receives the product notification at block 260 (e.g., in an email, on their facebook™ account, etc.), the user can decide to ignore the product notification (block 262). Accordingly, if the merchant does not receive an order (block 218), the merchant's web server will loop back to block 212 until another change in the product status occurs.

Alternatively, the user 102 may decide that they want to purchase the product (block 264). For example, the product notification may include a link that the user 102 may click on. The link may bring the user 102 to a product notification processing web page on the merchant's web site. There, the user 102 may purchase the product 108 online, or the user may elect to purchase the product in person at a brick and mortar retail store. In block 220, the merchant's web server may take appropriate action to conduct the purchase order.

Returning to block 260, yet another alternative is the user 102 declining to purchase the product and modifying their selection of product notification choices. Thus, in block 266, the user 102 may modify their selected criteria for when they receive subsequent product notifications and/or their selected communication channels over which they will receive subsequent product notifications. The user 102 may cancel some of their product notification choices. For example, the product notification processing web page on the merchant's web site may allow for the user 102 to modify their product notification selections. Or, the user 102 may browse the product description web page as they did in block 252 and re-trigger product tracking of the product 108 (block 256) to redefine when and how they want to receive product notifications for the product.

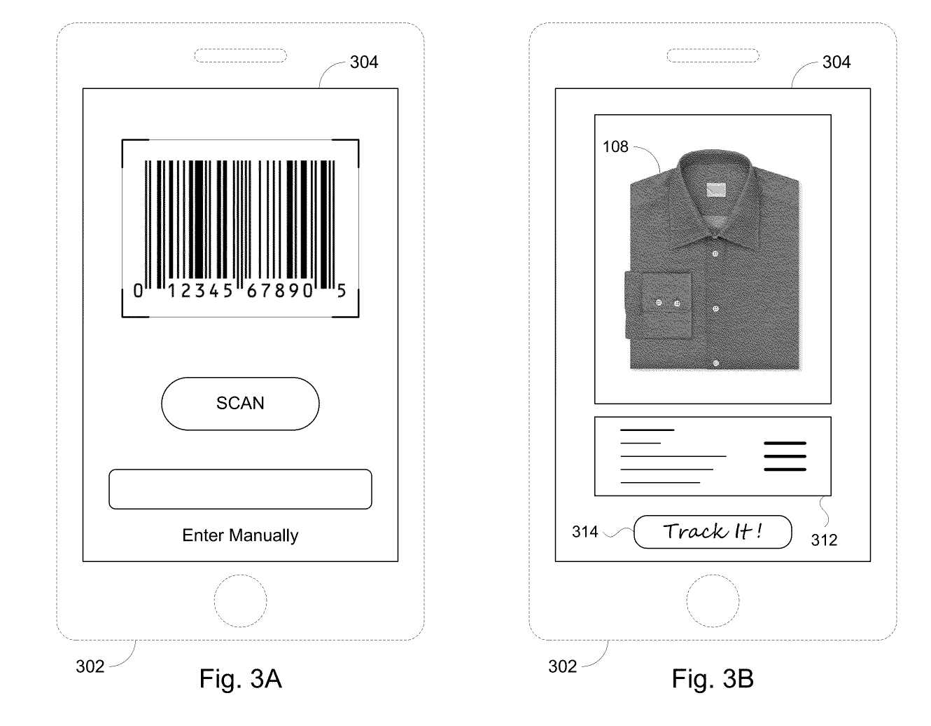

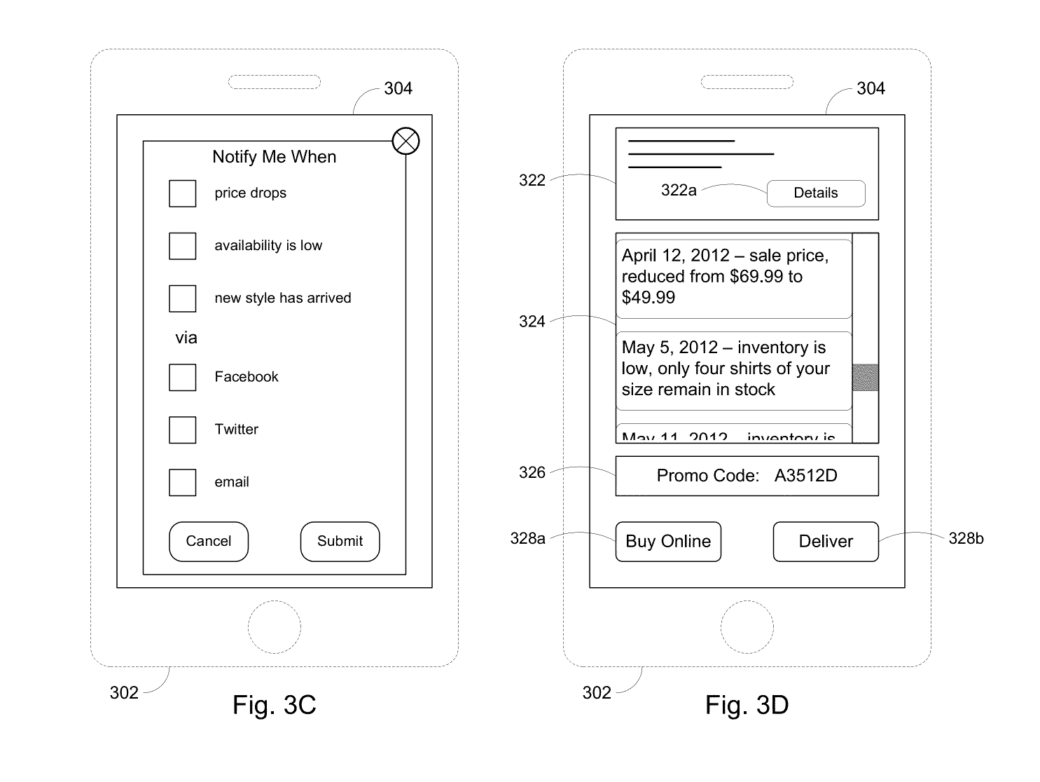

Referring now to FIGS. 3A-3D, illustrative user interface examples in accordance with the present disclosure are shown. The figures show a user interface that may be displayed on a mobile computing device 104 such as a smartphone 302 having a display screen 304. The figures illustrate a usage scenario in which the user 102 visits a brick and mortar retail store and sees a product (e.g., product 108) that they are interested in purchasing.

The user 102 may scan the product 108 in order to identify the product of interest. For example, a barcode scanning app installed on their smartphone 302 may scan the product 108 and display an image such as FIG. 3A on the display screen 304. A scan button allows the user 102 to scan in the code. Alternatively, the user 102 may manually enter in the barcode number if the code cannot be scanned, for example if the code is defaced.

Referring to FIG. 3B, the barcode scanning app may then browse to the merchant's web site with the scanned code and bring up a web page of the product 108. The web page may include additional information 312 about the product 108. In accordance with the present disclosure, the merchant's web site may include a track-it button 314 in the web page, if the merchant had set up the product 108 for product tracking. As explained above in the process flow described in FIG. 2, the track-it button 314 may allow the user 102 to trigger product tracking of the product 108.

Referring to FIG. 3C, an example of a display of notification choices that may be presented to the user 102 is illustrated. The user 102 may select “when” product notifications will be sent; e.g., by checking the checkbox next to each criterion. The figure shows a list of three criteria, but it will be appreciated of course that in other embodiments, the list may contain many more criteria. The user 102 may also select “how” the product notifications will be sent; e.g., also by checking the checkbox next to each communication channel. The figure shows a list of three communication channels (facebook, twitter, email), but it will be appreciated that other communication channels may included. Although not illustrated in FIG. 3C, the interface may be designed so the user 102 may select one or more communication channels for each criterion (e.g., “price drops”, “availability is low”, etc.). Thus, the user 102 can customize, for each criterion, how the corresponding product notifications will be communicated. For example, the user 102 may only want to be notified by email (via an email account) and a tweet (via a twitter™ account) for a product notification about “price drops”. However, the user 102 might want a product notification for “availability is low” to be posted only to the user's facebook™ account.

When the user 102 receives a product notification (e.g., via a facebook™ post), the notification may inform the user of the status change (e.g., price reduction). In some embodiments, the product notification may include a link that will take the user to a product notification processing web page, giving the user 102 options for responding to the product notification. FIG. 3D shows an example of a product notification processing web page, which may be hosted on the merchant's web site. In some embodiments, the product notification processing web page may include a product information area 322 that describes some details of the product. A button 322a may be in the provided product information area 322 to allow the user to receive additional information related to the product. A notification history 324 may show the user 102 of prior product notifications that were sent to the user.

A promotional code area 326 may be provided to offer a promotional code (e.g., coupon code) that can be used to facilitate the merchant's efforts in tracking its customers' purchases. An additional price discount may be associated with the promotional code in order to incentivize the user 102 to use the promotional code. For example, though not shown, the promotional code area 326 may include information to inform the user 102 that there is a price discount if the promotional code is used.

The product notification processing web page may include a “buy online” button 328a and a “deliver” button 328b. The “buy online” button 328a may allow the user 102 to purchase the product 108 online. The “deliver” button 328b may allow the user 102 to request that the product 108 be delivered to a brick and mortar retail store, where the user can make the purchase in person. For example, the “deliver” button 328b may lead the user to another screen (not shown) that allows the user 102 to select a store.

Product tracking in accordance with the present disclosure allows the merchant to customize their product notifications with a high degree of granularity. Only users who are interested in the product will receive product notifications. Each user specifies which product notifications they want to receive. Thus, user A may only want to receive product notifications relating to price reductions, while user B only wants to receive a product notification when the product is to be discontinued. Accordingly, the merchant may only send notifications of a sale on the product to user A, and may only sent a notification to user B if the product is going to be discontinued. Each user specifies their own communication channels. Thus, user A may receive product notifications about price reductions on their email account, while user C may receive the same product notifications on their twitter™ account.

In accordance with the present disclosure, the merchant may track users' buy actions when they make purchases on items that the merchant had set up for product tracking. Tracking the users' filtering criteria for product notifications, their selection of communication channels, when actual purchases were made, how the purchases were made (e.g., online, at a brick and mortar store, etc.), and so on may provide valuable analytics for the merchant in developing future marketing and sales campaigns.

For example, as mentioned above, the merchant may provide users with promotional codes. The promotional codes may identify that the product was part of a track-it marketing campaign. If a user makes an online purchase, the promotional code can be automatically applied to the sales order. In this way, the sales order generated for the sales of the product may be linked to both the user (through the user identity provided when they selected their communication channels) and the source of the sales order, namely the track-it marketing campaign. If a user chooses to have the product delivered to a brick and mortar store, a store delivery order may be generated. The promotional code may be associated with the store delivery order. When the user arrives at the store to make the actual purchase, the generated sales order may include the promotional code, thus linking the store sale to the track-it marketing campaign and the details of the user's product notification selections, as well as an identification of the user.

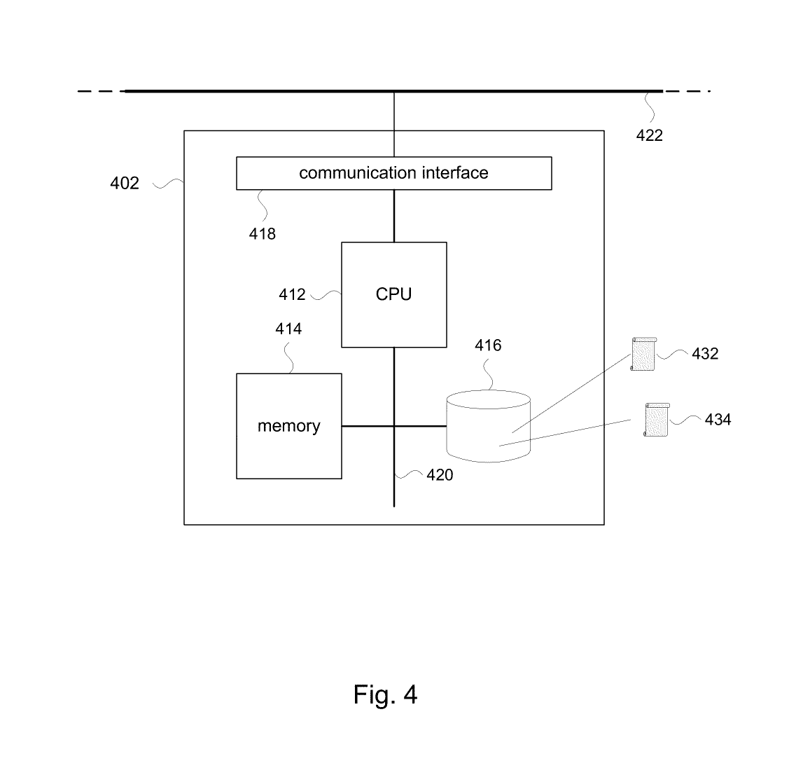

A particular embodiment of the computer system 104 in accordance with the present disclosure is illustrated in FIG. 4, showing a high level block diagram of a computer system 402 configured to operate in accordance with the present disclosure. The computer system 402 may include a central processing unit (CPU) or other similar data processing component. The computer system 402 may include various memory components. For example, the memory components may include a volatile memory 414 (e.g., random access memory, RAM) and a data storage device 416. A communication interface 418 may be provided to allow the computer system 402 to communicate over a communication network 422, such as a local area network (LAN), the Internet, and so on. An internal bus 420 may interconnect the components comprising the computer system 402.

The data storage device 416 may comprise a non-transitory computer readable medium having stored thereon computer executable program code 432. The computer executable program code 432 may be executed by the CPU 412 to cause the CPU to perform steps of the present disclosure, for example the steps set forth in FIG. 2. The data storage device 416 may include a relational database to store data 434 such as the product notification selections made by the user 102.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

1. A computer-implemented method for marketing a product comprising steps of:
a computer receiving from a user a product identifier that identifies the product;
the computer receiving from the user one or more notification choices that specify product notification content;
the computer generating a plurality of product notifications for the product; and
the computer sending to the user only those product notifications from among the plurality of product notifications which match up with at least one of the notification choices received from the user, wherein the user receives a product notification only when the product notification contains content specified in the one or more notification choices.

2. The computer-implemented method of claim 1 further comprising receiving from the user a designation of one or more communication channels, wherein product notifications that are sent to the user are sent via the one or more communication channels.

3. The computer-implemented method of claim 1 further comprising sending to the user a plurality of notification choices from which the one or more notification choices are selected.

4. The computer-implemented method of claim 3 wherein the notification choices include a list of communication channels.

5. The computer-implemented method of claim 1 further comprising receiving from the user an identification of the product and, in response, sending to the user a web page for tracking the product including a plurality of notification choices which define a plurality of product notifications for the product that the server system can send to the mobile device.

6. The computer-implemented method of claim 1 wherein receiving a product from the user comprises sending a web page to the user and receiving a selection of the product when the user clicks on a link in the web page that is associated with the product.

7. The computer-implemented method of claim 1 wherein the step of sending includes sending a product notification over a communication channel that varies depending on content of the product notification.

8. The computer-implemented method of claim 1 wherein the product identifier comprises a scanned barcode that is associated with the product.

9. The computer-implemented method of claim 8 wherein the barcode is a 2-D barcode.

10. A server system for marketing a product comprising:
a computer;
a data store; and
executable program code stored on the data store,
wherein the executable program code is configured to cause the computer to:
receive from a user a product identifier that identifies the product;
receive from the user one or more notification choices;
generate a plurality of product notifications for the product; and
send to the user only those product notifications from among the plurality of product notifications which match up with at least one of the notification choices received from the user, wherein the user receives a product notification only when the product notification contains content specified in the one or more notification choices.

11. The server system of claim 10 wherein the executable program code is further configured to cause the computer to receive from the user a designation of one or more communication channels, wherein product notifications that are sent to the user are sent via the one or more communication channels.

12. The server system of claim 10 the executable program code is further configured to send to the user a plurality of notification choices from which the one or more notification choices are selected.

13. The server system of claim 12 wherein the notification choices include a list of communication channels.

14. The server system of claim 10 wherein the executable program code is further configured to receive from the user an identification of the product and, in response, to send to the user a web page for tracking the product including a plurality of notification choices which define a plurality of product notifications for the product that the server system can send to the mobile device.

15. The server system of claim 10 the executable program code is further configured to send a web page to the user and to receive a selection of the product when the user clicks on a link in the web page that is associated with the product.

16. The server system of claim 10 wherein the executable program code is further configured to send the product notification over a communication channel that varies depending on content of the product notification.

17. The server system of claim 10 wherein the product identifier comprises a scanned barcode that is associated with the product.

18. The server system of claim 17 wherein the barcode is a 2-D barcode.

19. A non-transitory computer readable storage medium having stored thereon computer executable program code, wherein when a computer executes the computer executable program code, the computer performs steps of:
receiving from a user a product identifier that identifies the product;
receiving from the user one or more notification choices;
generating a plurality of product notifications for the product; and
sending to the user only those product notifications from among the plurality of product notifications which match up with at least one of the notification choices received from the user, wherein the user receives a product notification only when the product notification contains content specified in the one or more notification choices.

20. The non-transitory computer-readable storage medium of claim 19 wherein the step of sending includes sending a product notification over a communication channel that varies depending on content of the product notification.
